(19) United States
(12) Patent Application Publication
(10) Pub. No.: US 2013/0206238 A1
(43) Pub. Date: Aug. 15, 2013

(54) Valve Assembly and Method of Using Same

(71) Applicants: David Gent, Houston, TX (US); John Dernovsek, Wiarton (CA); Darin Carlson, Cypress, TX (US); Frank Raymond, Houston, TX (US)

(72) Inventors: David Gent, Houston, TX (US); John Dernovsek, Wiarton (CA); Darin Carlson, Cypress, TX (US); Frank Raymond, Houston, TX (US)

(21) Appl. No.: 13/697,921

(22) PCT Filed: May 13, 2011
(86) PCT No.: PCT/US11/36498

§ 371 Date: Jan. 28, 2013

Related U.S. Application Data
(60) Provisional application No. 61/334,915, filed on May 14, 2010.

(51) Int. Cl. F16K 1/22; F16K 37/00; F16K 3/08

(52) U.S. Cl. CPC F16K 1/224; F16K 3/08; F16K 37/00
USPC 137/1; 251/308; 137/553

(57) ABSTRACT

A valve and method for use is provided. The valve has a valve body having an outer perimeter and an inner perimeter defining a flow path therethrough. The valve has a closure member within the inner perimeter configured to selectively close and open the flow path. The valve has a valve seat located at least partially within the inner perimeter and configured to engage a portion of the closure member when the closure member is in a closed position. The valve has a stem configured to support the closure member within the flow path wherein a portion of the stem has an actuator offset. The valve has a bearing pedestal configured to support the stem. The valve has a closure member-stem connector configured to rotationally couple the closure member to the stem while allowing the closure member to move relative to the stem along a longitudinal axis of the stem.

### CROSS-REFERENCE TO RELATED APPLICATIONS

This application claims the benefit of U.S. Provisional Application No. 61/334,915 filed May 14, 2010.

### BACKGROUND

The geometry of a butterfly valve is well known in the industry. In a butterfly valve a disc rotates in a flow path to seal the flow path. In typical butterfly valves, the valve disc moves through its full arc of ninety degrees of rotation, the diametrical axis of the disc will be parallel to the flow axis of the flow path when the valve is fully open, and the diametrical axis of the disc will be precisely perpendicular to the flow axis of the flow path, or flow way, when the valve is fully closed.

In a traditional butterfly valve, the disc geometry helps to effect and maintain a continued seal between the valve parts when the valve is sealed. Over time, particulate in the flow path collects on valve pieces inside of the valve body. When the valve is installed with the stem in a vertical position, the particulate tends to collect in the area where the disc, stem and bearings interact with the valve body due to the effects of gravity. Problems can particularly arise when the particulate causes harm to the surfaces and the seal between these parts.

In some cases the valve body and actuator may be oriented such that the valve stem is not oriented to the vertical. In this manner the effect of gravity can be used to draw the particulate to a lower lying region within the valve body that does not coincide with the region where the valve stem and disc are supported by the valve seat. However, many valve and actuator installations do not allow such an orientation due to the confinement of space or other customer needs in the area of the installation. In other words, many customers prefer a vertical orientation of the valve stem (e.g. the actuator mounted on top) to preserve space, or for other reasons such as optimum functionality of the actuator.

Another area of concern relates to the edges of the valve seat, the disc seal and the disc in that it is desirable that all fit together when the valve is closed. Scratches in the edges of the valve seat, the disc seal, and/or the disc can create a leak. In prior devices the stem is rigidly connected to the disc. For example, in many systems the stem is pinned to the disc. Problems can arise when the actuator is installed on the valve body due to the rigidity of this connection. The actuator can be quite massive and upon installation the opportunity exists to apply axial force to the stem. This axial force can be applied more than once (in a tapping manner) as the actuator is positioned onto the stem. Tapping of the stem can result in cuts or scratches on the edges of the disc seal and/or the valve seat as forces are translated to the disc and the seat via the rigid connection. Therefore, a need exists for a more efficient valve.

### SUMMARY

Embodiments described herein provide a valve having a valve body having an outer perimeter defining the outer surface of the valve and an inner perimeter defining a flow path through the valve. The valve has a closure member located within the inner perimeter of the valve body. The closure member is configured to selectively close and open the flow path. The valve has a valve seat located at least partially within the inner perimeter of the valve body and configured to engage a portion of the closure member when the closure member is in a closed position, thereby preventing flow through the flow path. The valve has a stem configured to support the closure member within the flow path wherein a portion of the stem has an actuator offset. The actuator offset is configured to actuate the closure member to a position that is a rotational degree beyond the position wherein the closure member is perpendicular to the flow path. The valve has a bearing pedestal configured to support the stem and a closure member-stem connector. The closure member-stem connector may be configured to rotationally couple the closure member to the stem while allowing the closure member to move relative to the stem along a longitudinal axis of the stem. The bearing pedestal may be a single piece, or multiple pieces.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic view of a piping system having a valve assembly.

FIG. 2 depicts a schematic view partially in cross section of the valve assembly of FIG. 1.

FIG. 3 depicts a schematic view partially in cross section of the valve assembly in a closed position.

FIG. 4A depicts a perspective view partially in cross section of the valve assembly.

FIG. 4B depicts a sectional view of a disc-stem connector of the valve assembly taken along line 4B-4B of FIG. 4A.

FIG. 5A depicts a view of a pedestal and a disc of the valve assembly.

FIG. 5B depicts a view of an alternate pedestal and the disc of the valve assembly.

FIG. 6 depicts a view of a stem-disc connector of the valve assembly.

FIG. 7 depicts a view of the disc and a valve seat of the valve assembly.

FIGS. 8A and 8B depict views of the valve assembly in alternative positions in the piping system.

FIG. 9 depicts a method for using the valve assembly.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

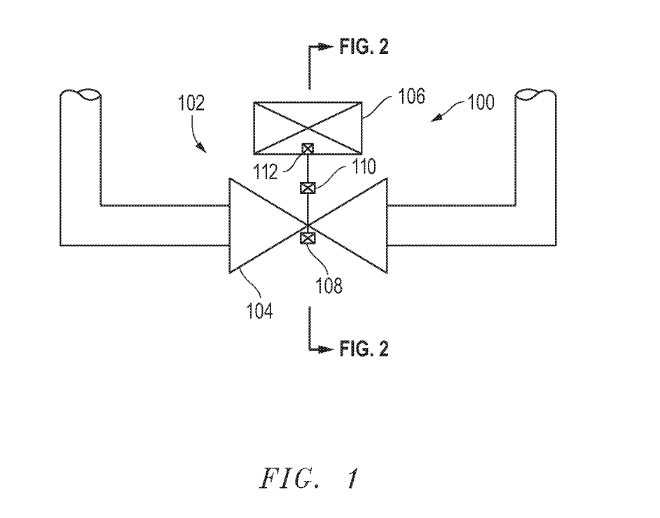

FIG. 1 depicts a schematic view of a piping system 100 having a valve assembly 102. The valve assembly 102 may be for controlling flow in the piping system 100. The valve assembly 102 may have a valve 104 and an actuator 106. The valve 104 is configured to control flow in the piping of the piping system 100. The valve 104 may be any suitable valve including, but not limited to a butterfly valve. The actuator 106 may be configured to automatically actuate the valve 104. For example, the actuator 106 may move a closure member 201 of the valve 104 from an open to a closed position, or from a closed to an open position. The valve assembly 102 may have a bearing pedestal 108, a closure member-stem connector 109 (shown as a disc-stem connector 110), and an offset 112 that enables the actuator 106 to actuate the valve 104 beyond the location of the traditional closed position. The support pedestal 108, the disc-stem connector 110 (or bearing coupler), and the offset 112 may allow the valve assembly 102 to work more efficiently and effectively during the life of the valve 106.

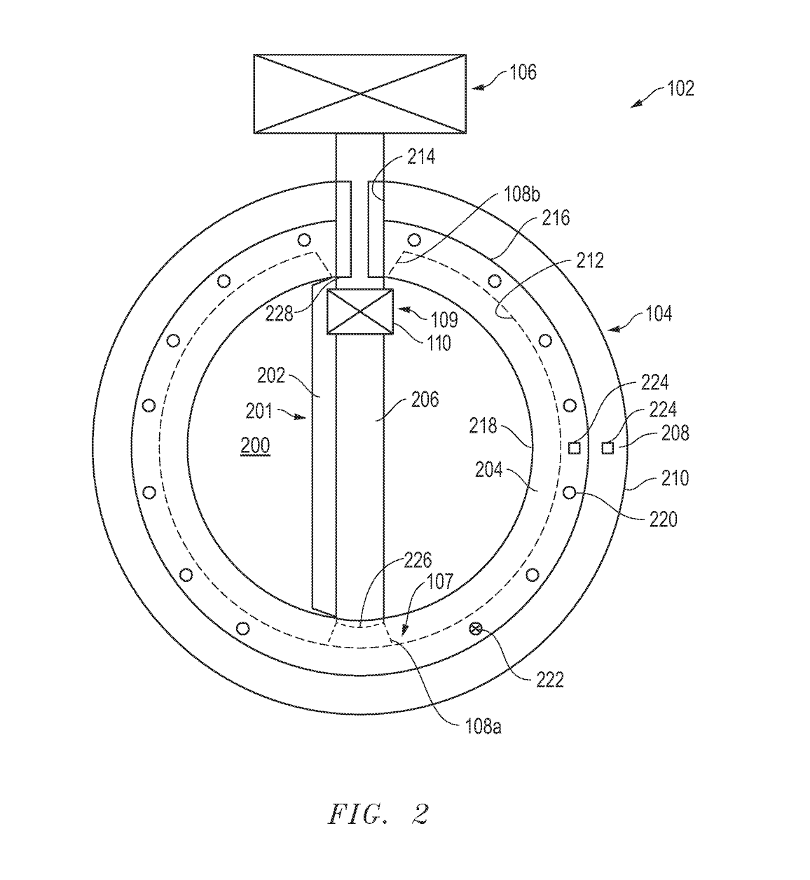

FIG. 2 depicts a schematic view of the valve assembly 102 partially in cross section. The valve 104 is shown in an open position looking into a flow way 200 of the valve 104. The valve 104 may have a closure member 201, shown as a disc 202, for sealing the flow way 200 against a valve seat 204. The disc 202 may be coupled to a stem 206 by the disc-stem connector 110. The stem 206 may be coupled to the actuator 106 in order to rotate the stem 206 and thereby move the disc 202 between the open position and the closed position, as will be described in more detail below. The stem 206 may preferably be positioned to overlap one side of the disc 202 and therefore may extend greater than 60% of the diameter of the disc 202. Further, the stem 206 may be stub shafts, or multi-piece stems, that run from the actuator to the pedestal 108a. Although the closure member 201 is shown as the disc 202, the closure member 201 may be any suitable member for sealing the flow path through the valve 104 including, but not limited to, a plug, a ball, a gate, a flapper, and the like.

The valve 104 may have a valve body 208 configured to provide support for the components of the valve assembly 102. The valve body 208 may have an outer perimeter 210 that defines the outer surface of the valve 104. The outer perimeter 210 may have any suitable coupling device (not shown) for coupling two halves of the valve 104 together, for example, bolts, welded connections and the like. The valve body may be adapted for a wafer, lug and/or flanged type valve body. The valve body 208 may have an inner perimeter 212 that defines the flow path through the valve 104. The inner perimeter 212 as shown is cylindrical shaped, however, it should be appreciated that the inner perimeter 212 may have any suitable shape that allows fluids to flow through the valve 104. The valve body 208 may have a stem bore 214 configured to allow the stem 206 to pass from the interior of the valve 104 to the exterior. The valve body 208 may have a notch 216 configured to receive a portion of the valve seat 204. The notch 216 as shown is a substantially circular groove for securing a portion of the valve seat 204 to the valve body 208.

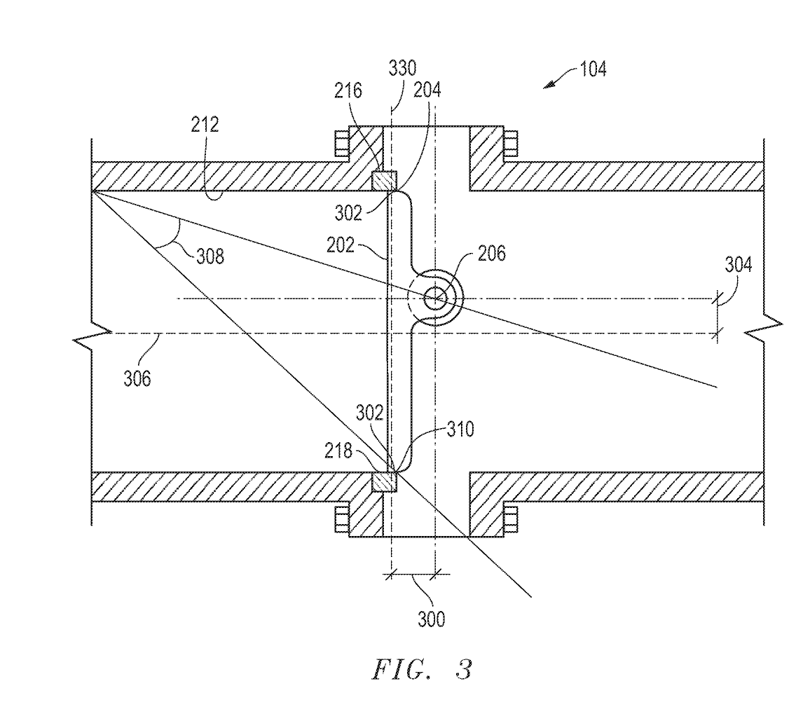

The valve seat 204 may provide a sealing surface for the disc 202 to engage in the closed position. As shown, the valve seat 204 is a ring that secures in the notch 216. A portion of the valve seat 204 may extend into the flow path 200. Thus, an inner diameter of the valve seat 204 may be smaller than the inner diameter of the inner perimeter 212 of the valve body 208. The valve seat 204 may have an engagement surface 218 as shown in FIGS. 2 and 3 for engaging the disc 202 in the closed position. The valve seat 204 may have one or more apertures 220 for securing the valve seat 204 to the valve body 208 with one or more fasteners 222. The fasteners 222 as shown are screws that allow the valve seat to be removed, repaired and/or replaced easily in the field. The fastener 222 may be any suitable fastener and/or retaining bolt, such as a full faced retainer bolt.

The valve seat 204 may be made from a metal, such as a laminated 321 stainless steel/graphite ring. Although the valve seat 204 is described as being a laminated 321 stainless steel, it should be appreciated that the valve seat 204 may be constructed of any suitable material, and/or combination of materials including, but not limited to another stainless steel, carbon steel, alloys, nickel alloys, and the like. The elasticity of the laminated ring may ensure uniform peripheral sealing with the valve seat 204 and the disc 202. The uniform peripheral sealing may allow the valve 204 to achieve full shutoff regardless of the flow direction in the valve 202.

The valve seat 204 may have one or more alignment marks 224 which correspond with one or more alignment marks 224 on the valve body 208. The alignment marks 220 may also be located on the disc 202. The alignment marks 224 may allow a worker to assemble the valve 104 easily with little chance of an alignment error. Having the valve seat 204 as a field replaceable item may reduce field maintenance costs.

The support pedestal 108a may protrude from the inner perimeter of the valve body 208. There may be a second pedestal 108b located near the top (as shown) of the valve body 208. As shown in FIG. 2, the pedestals 108a and 108b, or boss, or hub, may be a frusto-conical pedestal protruding into the flow path 200. The pedestals 108a and 108b are shown as being located on the upstream side of the valve seat 204. The pedestal 108a may have a bearing surface 226 for engaging the lower end of the stem 206. The pedestal 108b may have a partial bearing surface 228. The partial bearing surface 228 may have a stem hole 230 therethrough to allow the stem 206 to pass through to the actuator 106. By allowing the pedestals 108a and 108b, and thereby the bearing surface 226 and the partial bearing surface 228 to extend into the flow path 200, the bearing surface 226 and the partial bearing surface 228 may be located proximate the disc 202. This arrangement reduces the unsupported stem length by which stem deflection and strain during the operation under high pressure drops are greatly reduced. This reduction in deflection and strain may substantially enhance the performance and service life of the valve 104. Further, this arrangement reduces fluid from penetration and/or accumulation at the bearing surface 226 and the partial bearing surface 228.

The pedestals 108a and 108b may be made of a 316 stainless steel material. The stainless steel may be nitrite coated in one embodiment. The incorporation of advanced metallurgy in the bearing design may eliminate stem galling under heavy loads. Although, the pedestals 108a and 108b are described as being made of 316 stainless steel, it should be appreciated that any suitable material may be used such as stainless steel, carbon steel, alloys, nickel alloys, any combination thereof, and the like.

Although, the pedestals 108a and 108b are shown as having a frusto conical shape, any suitable shape that allows the bearing surface 226 and the partial bearing surface 228 to extend to a location proximate the disc 202 including, but not limited to, a cylindrical shape, convex shape, a boss, a hub, a dome, a rectangular prism, a tapered shape, and the like. Further, although there are two pedestals 108a and 108b shown, it should be appreciated that only one of the pedestals 108a and/or 108b may be present.

The pedestals 108a and 108b may be aligned with the stem 206. For example a centerline of the stem 206 may align with the centerline of the pedestals 108a and 108b. Therefore the stem 206 may align with a center of the bearing surface 228 and/or the partial bearing surface 228. Although the pedestals 108a and 108b are described as being aligned with the centerline of the stem 206, it should be appreciated that any suitable offset may be used.

The pedestals 108a and/or 108b may extend radially from the inner perimeter 212 of the valve body 208 to a location proximate the engagement surface 218 of the valve seat 204 and/or the disc 202. Although the pedestals 108a and/or 108b may be located close to the disc 202, the pedestals 108a and 108b will not interfere with the rotation of the disc 202. The distance the pedestals 108a and/or 108b may extend radially toward the disc 202 and/or the engagement surface 218 may be at least two percent or more or the valve inner diameter and ten percent or more of the diameter of the valve stem 206 in one embodiment. Further, the distance the pedestals 108a and/or 108b extend radially toward the disc 202 may be any suitable distance that does not interfere with the operation of the disc 202.

The bearing surface 226 and/or the partial bearing surface 228 may have any shape suitable for supporting the stem 206 in the valve 104. As shown in FIG. 2, the bearing surface 226 may be a substantially flat circular surface for engaging a lower end of the stem 206. The partial bearing surface 228 may be a flat doughnut shaped ring for supporting the upper end of the stem 206 in the flow path 200 while allowing a portion of the stem 206 to penetrate the partial bearing surface 228. Although the bearing surface 226 and the partial bearing surface 228 are described as being substantially flat, the bearing surface 226 and the partial bearing surface 228 may be curved to better support the stem 206. For example, the bearing surface 226 and the partial bearing surface 228 may be slightly concave and/or convex to accommodate the shape of the stem 206.

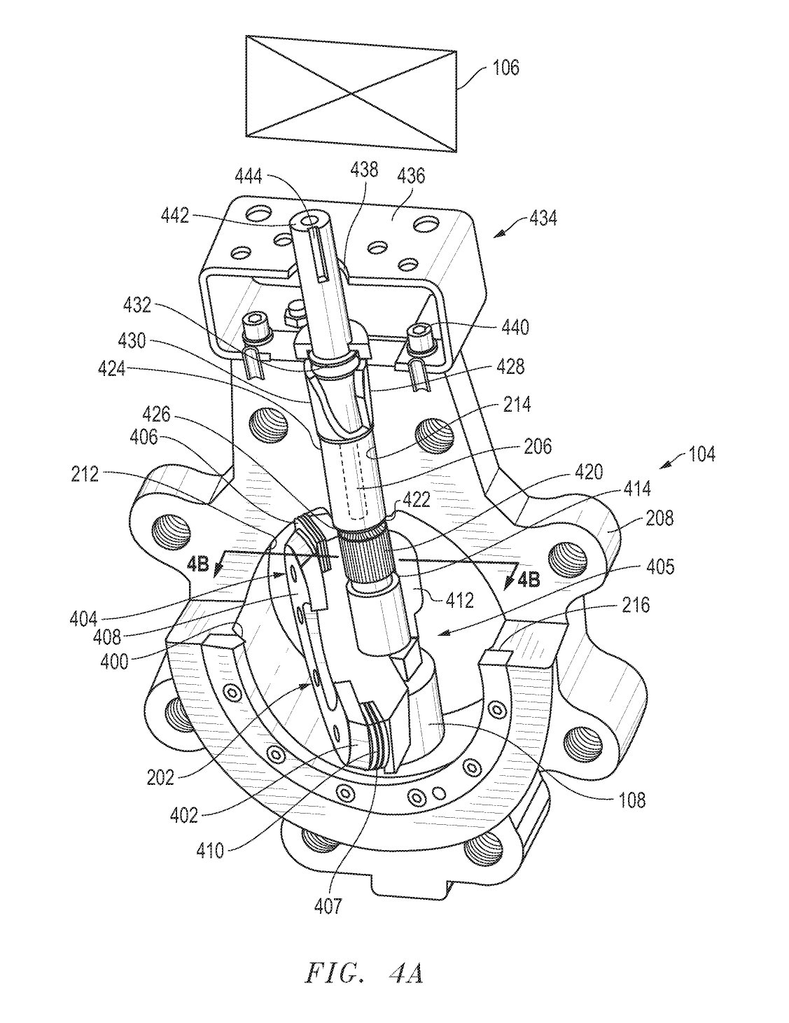

FIG. 3 depicts a cross-sectional top view of the valve 104 according to an embodiment. The valve 104 as shown may be a triple offset valve. The triple offset design may allow the valve 104 to form a metal to metal seal between the valve seat 204 and the disc 202 without interference from the stem 206, and/or other valve components. A first offset 300 may be the offset between a centerline of the stem 206 and a seal surface 302 between the disc 202 and the valve seat 204. The first offset 300 may allow the disc 202 to form a continuous sealing surface with the valve seat 204 which is uninterrupted by the stem 206. A second offset 304 may be the offset between the centerline of the stem 206 and a valve centerline 306. The second offset 304 may produce a cam like rotary motion of the disc 202. The cam like rotary motion may pull the disc 202 edge from the seat 204 upon opening. As the disc 202 reaches the closed position, as shown in FIG. 3, the second offset 304 converts the cam like rotary motion into a linear motion that pushes the disc 202 into the valve seat 204. The disc 202 edge may not contact the seat 204 throughout the full range of travel of the disc 202. The third offset 308 may be a conical seal 310 between the valve seat 204 and the disc 202. The conical seal 310 may be formed by a frusto-conical valve seat surface 400 and/or a frusto-conical disc seal surface 402, as shown in FIG. 4A. The conical seal 310 may facilitate rotary disengagement of the disc 202 from the valve seat 204. This cone in cone geometry removes the entire disc 202 edge from the valve seat 204 immediately upon opening rotation of the disc 202 by the stem 206. Further, the conical seal 310 engages the contact during closing of the valve 104. Therefore all of the interference between the disc 202 and the valve seat 204 may be eliminated using the third offset 308 to form the conical seal 310.

FIG. 4A depicts a partial cross sectional view of the valve 104 according to an embodiment. The disc 202 is shown in a position between the open position (as shown in FIG. 2) and the closed position (as shown in FIG. 3). The disc 202 may have an optimized profile to provide maximum strength and maximum flow capacity in the open position. The disc 202 may have an engagement portion 404 and a stem connection portion 405. The engagement portion 404 may be configured to engage and seal the disc 202 against the valve seat 204. The engagement portion 404 may have the frusto-conical disc seal surface 402, an engagement shoulder 406, a disc edge 407, and a disc face 408. The engagement shoulder 406 may be configured to engage a back portion of the valve seat 204, and/or the valve body 208, in the closed position. In another embodiment, the engagement shoulder 406 may be configured to be spaced away from the valve seat 204 and/or the valve body 208 in the closed position. The disc 202 and/or the components of the disc 202 may be made of any suitable material including those described herein.

The disc edge 407 may be configured to seal against the inner perimeter 212 of the valve body 208 in the closed position. The disc edge 407 may have one or more replaceable disc seals 410. The disc seals 410 may be constructed of any suitable material including, but not limited to, metal, elastomer, rubber and the like. The replacement of the disc seals 210 in the field may allow the operator to easily remove and replace the disc seals 210 and refurbish the valve 104 in the field. Because the disc 202, the valve seat 204 and the valve body 208 may have multiple seal surfaces and multi-directional seal surfaces, the sealing capability of the valve 102 is greatly increased. The multi-directional seals may ensure reduced, or zero, leakage throughout the full pressure and full temperature range of the valve 102. Further, the disc edge 407, and/or the disc seals 410 may be configured to engage a portion of the pedestal 108a and/or 108b in order to support the disc 202 within the valve 104.

The disc face 408 may be configured to seal the flow path 200 in the closed position. The disc face 408 as shown is a substantially circular member configured to be located proximate the inner diameter of the valve seat 204 in the closed position. Although the disc face 408 is shown as a circular member, it should be appreciated that the disc face 408 may have any suitable shape for blocking the flow path 200 when the disc 202 is in the closed position.

The stem connection portion 405 of the disc 202 may be configured to receive the stem 206 for operation of the disc 202 in the valve 104. The stem connection portion 405 may have a housing 412. The housing 412 may have a receiving bore 414 for coupling the disc 202 to the stem 206. In addition, the housing 412 may be configured to couple to the engagement portion 404 of the disc 202. The housing 412 may couple to the engagement portion 404 using any suitable method including, but not limited to, welded, bolting, may be an integral piece of the engagement portion 404 and the like.

The disc-stem connector 110 allows axial movement of the stem 206 relative and independent of the disc 202. Therefore, the seal between the valve seat 204 and the disc 202 may remain stationary even when the stem is moved longitudinally during operation. For example, an operator may inadvertently move the stem 206 while installing the actuator 106, or by hitting the actuator 106 and/or stem 206. Further, any longitudinal movement of the stem 206 due to thermal expansion or pressure effects on the bottom of the stem 206 in the valve 102 will not be transferred to the disc 202. The disc-stem connector 110 may prevent misalignment problems of rigidly attached stems (not shown). Further, the disc-stem connector 110 may eliminate exposure of stem retention components (not shown) typically used in valves. These stem retention components may include, but are not limited to, pins or taper pins. These traditional stem retention components cause leak paths, erosion, corrosion and vibration failures in the valves in addition to requiring difficult machining, assembly, and disassembly. The disc-stem connector 110 allows the stem 206 to be slid into the receiving bore 414 for easy assembly and disassembly. Although, one disc-stem connector 110 is shown near the top portion of the disc 202 to stem 206 interface, there may be multiple disc-stem connectors 110 located along the stem 206. Further, the location of the disc-stem connector 110 may vary along the length of the stem 206 so long as the disc-stem connector 110 allows for the transfer of torque to the disc 202.

The disc-stem connector 110 may be a connection between the receiving bore 414 and the stem 206. The disc-stem connector 110 may allow the stem 206 to move longitudinally within the receiving bore 414 while preventing relative rotation between the stem and the receiving bore 414. As shown in FIG. 4A, the stem 206 may have a splined portion 420. The splined portion 420 may be configured to be located within a splined bore 422 of the receiving bore 414. FIG. 4B depicts a cross sectional view of a disc-stem connector 110. As shown, the splined portion 420 may be slightly smaller than the splined bore 422 thereby allowing the stem 206 to slide into and longitudinally move relative to the disc 202 (as shown in FIG. 4A). The close tolerance between the splined portion 420 and the splined bore 422 is not necessarily as represented in FIG. 4B and may eliminate hysteresis. Although the splined connection is shown as having multiple sharp points/edges it may take any form suitable for transferring torque including, but not limited to, rounded edges, chamfered edges, sinusoidal, and the like. The splined portion 420 and the splined bore 422 may extend the length of the receiving bore 414 or only a portion thereof as shown (i.e. may be longer or shorten than represented in the figures of the drawings). Although the disc-stem connector 110 is shown as a splined connection, it should be appreciated that any suitable socket shape for allowing the stem 206 to move longitudinally while preventing relative rotation may be used including, but not limited to, a triangular cross section, a square cross section, a pentagon cross section, a hexagon cross section, an octagon cross section, a shaped cross section and the like.

The materials used for the stem 206 and/or the disc 202 may be similar to prevent variation in thermal expansion and yield strength. Further, the materials may be dissimilar depending on the use, temperature and pressure of the valve. The stem 206 and the disc 202 may be constructed of any suitable materials including, but not limited to, those described herein.

The stem bore 214 through the valve body 208 may have a stem bearing 424 configured to support and seal the stem 206 in the valve body 208. The stem bore 214 may act as an inboard body hub for the stem bearing 424, or bearing system. The bearing system may minimize bending and strain in the stem 206. The bearing system may support the stem 206 and eliminate galling. Further, the bearing system may prevent process debris ingress. The bearing system may further maintain the disc 202 alignment with the valve seat 204. The stem bearing 424 may be any suitable bearing located in the stem bore 214 to radially support the stem 206 and prevent ingress or egress of debris to and from the valve 104. The stem bearing 424 may have one or more bearing seals 426 to prevent flow to and from the interior of the valve 104.

The valve 104 may have a stem packing gland 428. The stem packing gland 428 may allow for easy access to a stem seal system 230 in the field to allow for easy adjustment of the stem seal system 430. Further, the stem seal system 430 may eliminate fugitive emissions to and/or from the interior of the valve 104. A stem blowout prevention ring 432 may be used to prevent the stem 206 from ejecting from the valve 104 in the unlikely event of an internal failure in the valve 104.

The stem 206 may be a continuous component through the disc 202, the stem bearing 424, the stem packing gland 428, the stem seal system 430, and/or the stem blowout prevention ring 432, or the stem may be two or more portions coupled together.

An actuator mount 434 may be coupled to the top of the valve body 208. The actuator mount 434 may provide a mounting surface 436, or universal mounting surface, for coupling to the actuator 106 (as shown in FIG. 1). The actuator mount 434, as shown, has a stem bore 438 for allowing the stem 206, the stem packing gland 428, and/or the stem bearing 424 to penetrate the actuator mount 434. The actuator mount 434 is shown as a substantially rectangular shaped bracket although the actuator mount 434 may be any suitable shape for coupling the actuator 106 to the valve 104 including, but not limited to, square, oval, round, and the like. Further, it should be appreciated that the actuator mount 434 may be integral with the valve 104. The actuator mount 434 as shown is coupled to the valve body 208 using one or more bolts 440, although it should be appreciated that any fastener or weld may be used. In one embodiment, the actuator mount 434 and stem connection conform with ISO 5211.

The actuator 106 may mount directly to the mounting surface 436 and couple to the stem 206. The actuator 106 may have any suitable coupling means (not shown) for coupling to the stem 206. The coupling means may couple to the top end of the stem 206. The actuator 106 may have an internal drive means (not shown) for moving the stem 206 and thereby the disc 202 between the open and closed positions. The actuator 106 as shown is an automatic actuator, although it should be appreciated that any suitable actuator may be used including, but not limited to, a hand wheel, a manual gearbox, a pneumatic actuator, a hydraulic actuator, an electric actuator, a mechanical actuator, any combination thereof, and the like.

An actuator end of the stem 206 may have a disc position indicator 442. The disc position indicator 442 may be configured to indicate the position of the disc 202 in the valve 102 (e.g. fully “open”, fully “closed”, etc.) to the actuator 106 and/or an operator. Therefore as the disc position indicator 442 moves with the stem 206, the disc 202 moves between the open and/or closed position. As shown, the disc position indicator 442 is a notch cut into the actuator end of the stem 206, although any suitable device may be used on the stem 206 to indicate the position of the disc 202. The disc position indicator 442 provides a clear verification of the location of the disc 202 in the valve 102.

The actuator end of the stem 206 may have at least one drive coupling surface(s) 444 machined into the actuator end of the stem 206. The drive coupling surface 444 may be for coupling to the actuator coupling and for being driven by the actuator 106. The drive coupling surface 444 may be any suitable surface, device, and/or system for coupling the stem 206 to the actuator 106 including, but not limited to, a double D coupling, a spline coupling, a keyed coupling, a pinned coupling, disc screws, taper pins, key ways, mechanical fasteners, multiple drive couplers, any combination thereof, and the like

In one embodiment, the disc position indicator 442 may track a ninety (90) degree range of motion of the stem 206 and thereby the disc 202. The ninety degree range may represent the range of motion of the disc 202 between the open and closed position. The notch in the stem 206 may represent or correspond to the detected ninety (90) degree motion.

In one embodiment, the drive coupling surface(s) 444 is made relative to the actuator coupling and the disc position indicator 442 such that the drive coupling surface(s) 444 is slightly offset, staggered, or skewed within the range of about 1 to 5 degrees relative to where it was aligned and machined in the prior art valves. As shown, the drive coupling surface(s) 444 look to be substantially parallel with the disc 202; however, the drive coupling surface(s) 444 may be slightly offset as described herein. The effect and functionality to be achieved is that as the disc 202 moves through its full arc of rotation (for example the ninety degree (90)), the diametrical axis 330 of the disc 202 will be leading by about 1 to 5 degrees from parallel to the flow axis (represented by the centerline 306 of the flow path 200 as shown in FIG. 3) of the flow path 200 when the valve 104 is fully open, and the diametrical axis 330 of the disc 202 will be leading by about 1 to 5 degrees from perpendicular to the flow axis of the flow path 200 when the valve 104 is fully closed. Accordingly, when fully closed the diametrical axis 330 of the disc 202 will be rotated about 1 to 5 degrees beyond the position where it perpendicularly sealed metal to metal with the valve seat 204 in a triple offset valve.

The offset, or actuation offset, of about 1-5 degrees may provide many advantages over the life of the valve 104. For example over time and the cycles of operation, a better seal between the disc 202 and the valve seat 204 will be maintained upon closing of the valve 104 because the range of closing motion extends beyond (about 1-5 degrees) the traditional actuation motion of typical valves. Although, the actuation offset is described as being about 1-5 degrees beyond the normal closed position, it should be appreciated that any suitable range may be used such as any greater than 0 degrees and less than 10 degrees.

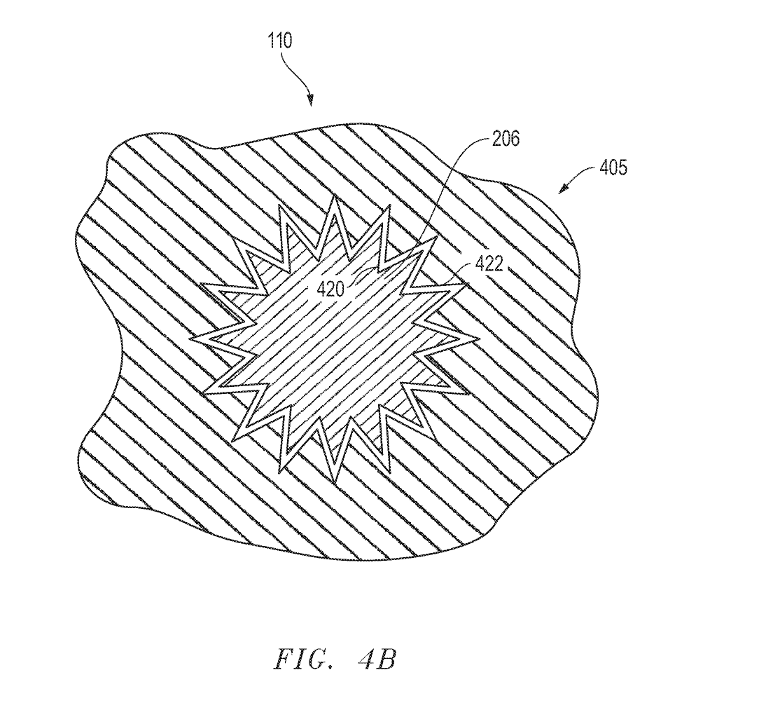

FIG. 5A depicts a view of the pedestal 108a according to an embodiment. The pedestal 108a may allow the stem 206 and the disc 202 to operate above the inner perimeter 212 of the valve body 208. During the life of the valve 104, debris and/or particulate may accumulate toward the bottom of the valve, or at the bottom of the inner perimeter 212. The pedestal 108a may move the disc 202 above this location thereby making the operation of the disc 202 in an area free of debris. The pedestal 108a also reduces the unsupported stem length, with the stem bearings complementary to or supporting the back-face of the disc 202. This reduces stem deflection and strain during operation. The height of the pedestal 108a may protrude two percent or more of the valve inner diameter and ten percent or more of the valve shaft diameter into the opening of the flow path 200. Particles catch at the basin 107 (see FIG. 2 and FIGS. 5A & 5B) of the boss (or the pedestal 108a) instead of at the location where valve stem 206 and disc 202 interact with the valve seat 204 and away from the location where the stem 206 journals to the disc 202.

FIG. 5B depicts a view of the pedestal 108a as a multi piece pedestal. As shown, the pedestal 108a has a bearing portion 500 and a base portion 502. The base portion 502 may have a shoulder 504, or rim defining and surrounding a cavity, or recess, in the base portion 502. The bearing portion 500 may have a male portion 506 configured to enter the cavity and substantially secure the bearing portion 500 to the base portion 502. The male portion 506 and the cavity may prevent the bearing portion 500 from moving laterally relative to the base portion 502. Although only two portions of the multi piece pedestal are shown, there may be more than two pieces of the multi piece pedestal. The multi piece pedestal may allow for adjustment of the size of the pedestal 108a. Although the multi piece pedestal is shown in conjunction with the pedestal 108a, it should be appreciated that the second pedestal 108b may be a multi piece pedestal. Further, any suitable system may be used to connect the bearing portion 500 with the base portion 502 including, but not limited to, welding, tack welding, screwing, bolting, and the like.

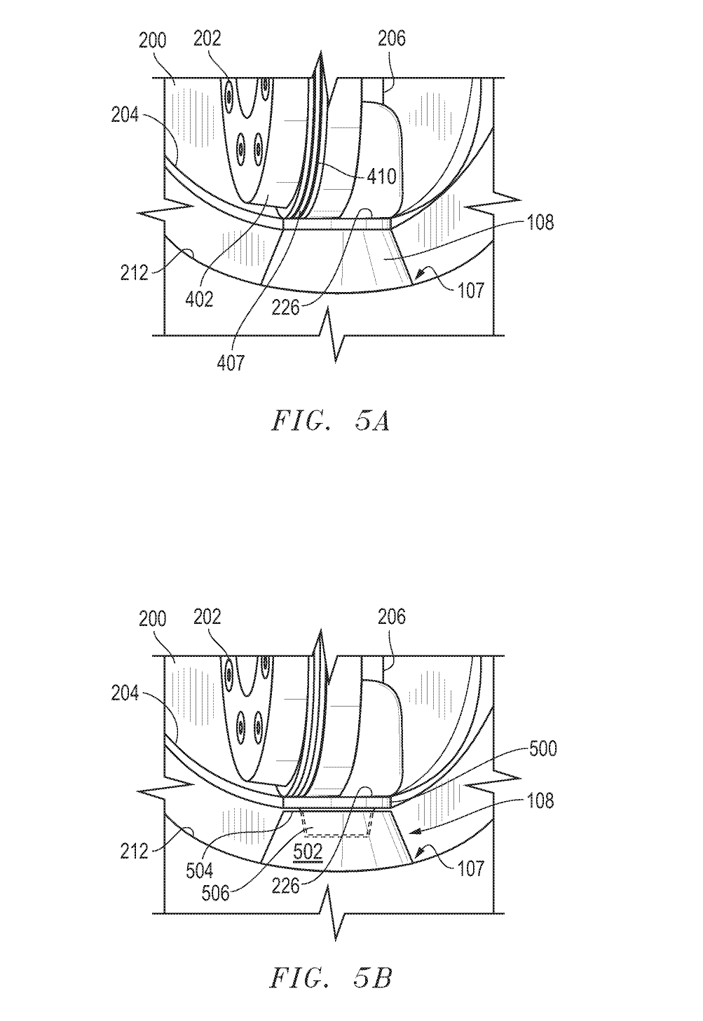

FIG. 6 depicts the disc-stem connector 110 according to an embodiment. As shown, the disc-stem connector 110 is a splined connection. The disc-stem connector 110 transfers rotation, or torque, from the stem to the disc while allowing the disc to move axially independent of the stem 206. The independent axial movement of the stem 206 relative to the disc 202 prevents any vertical force to the stem 206, for example from tapping or hammering of the actuator 106, to be transferred to the disc 202. This will protect the disc 202 and as such will not drive the edges of the disc seal 207 against the edges of the valve seat 204, thereby reducing the opportunity for cuts and scratches on the edges of the disc seat 207 and the edge of the valve seat 204. Temperature and pressure effects on the base of the stem 206 will not axially translate to the disc 202, thereby helping to preserve the seal.

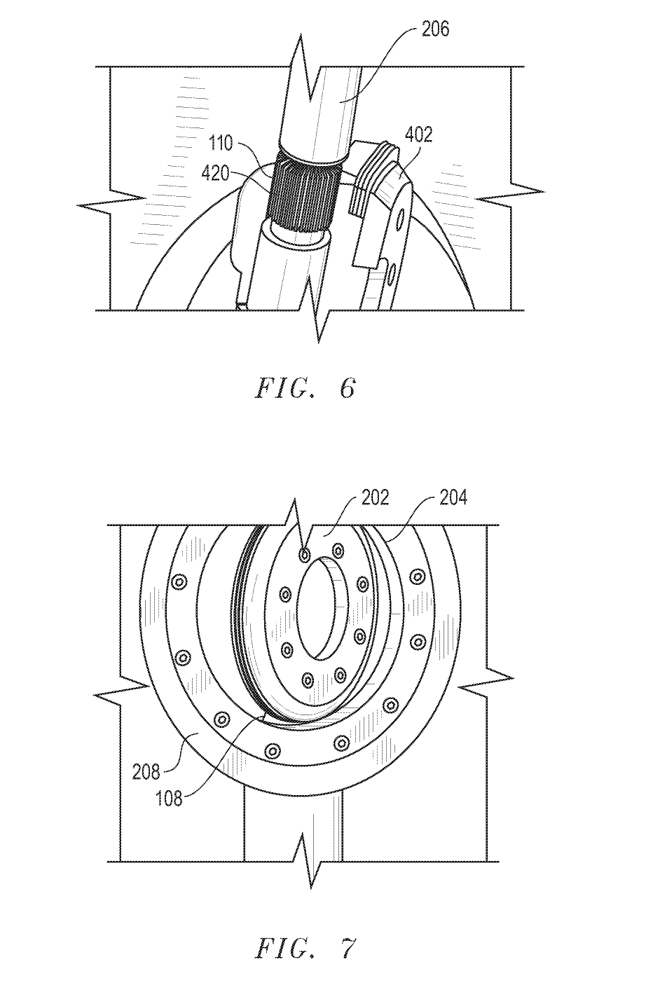

FIG. 7 depicts a view of the valve seat 204 and the disc 202. The stem 206 (shown in FIG. 4A) may have the offset, or actuator offset to ensure that the seal between the valve seat 204 and the disc 202 are maintained over the life of the valve. The actuator offset may couple the stem to the actuator such that the stem 206, and thereby the disc 202, is advanced about one to five degrees beyond where it was positioned in prior art valves (note that in prior art valves the stem was coupled such that as the actuator rotates the stem, for example, an arc of 90°, the stem 206 and hence the disc 202 would rotate from a position in which the diametrical axis of the disc is parallel to the flow axis of the flow way when the valve is fully open, and the diametrical axis of the disc is perpendicular to the flow axis of the flow way when the valve is fully closed). In one embodiment, the one to five degree advancement, or actuator offset, may be accomplished by machining the stem 206 on the end that couples to the actuator 106 such that the disc position indicator 442 notch and drive coupling surface(s) 444 of the stem 206 are slightly staggered or skewed within the range of about 1 to 5 degrees relative to where the notch and drive coupling surface(s) were built and aligned in the prior art valves. The effect and functionality to be achieved is that as the disc 202 moves through its full arc of rotation, the diametrical axis of the disc 202 will be leading by about 1 to 5 degrees from parallel to the flow axis of the flow way when the valve 104 is fully open, and the diametrical axis of the disc 202 will be leading by about 1 to 5 degrees from perpendicular to the flow axis of the flow path 200 when the valve 104 is fully closed.

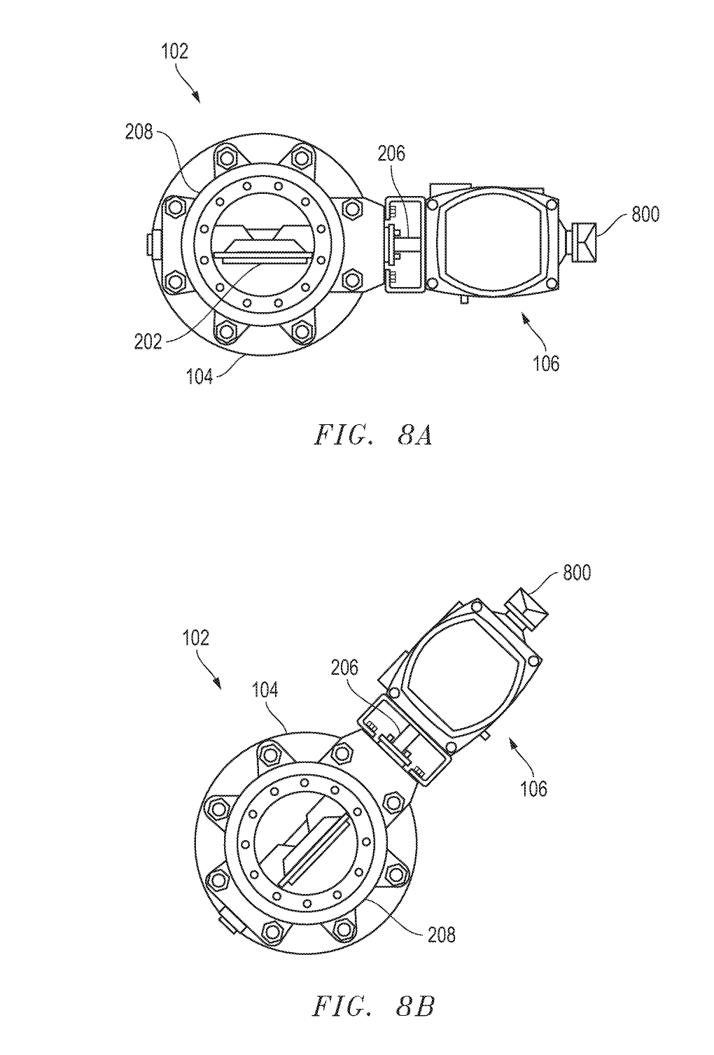

FIGS. 8A and 8B respectively depict the valve 104 and actuator 106 in a horizontal and angled mounting position in the piping system. In the horizontal mounting position the alignment of the stem 206 and the actuator 106 are horizontal relative to the ground. In the angled mounting position the alignment of the stem 206 and the actuator 106 are orientated at an angle between the vertical position (shown in FIGS. 1-7) and the horizontal position (shown in FIG. 8A).

A disc indicator 800 may be located on the actuator 106. The disc indicator 800 may visually represent the location of the disc position indicator 442 (as shown in FIG. 4A) and thereby the relative position of the disc 202. The disc indicator 800 may give an operator a quick and easy way to ensure the position of the valve. Although the disc indicator 800 is shown as a visual indicator, it should be appreciated that any indication system may be used to alert the operator, or a computer, of the location of the disc position indicator 442 and thereby the disc 202.

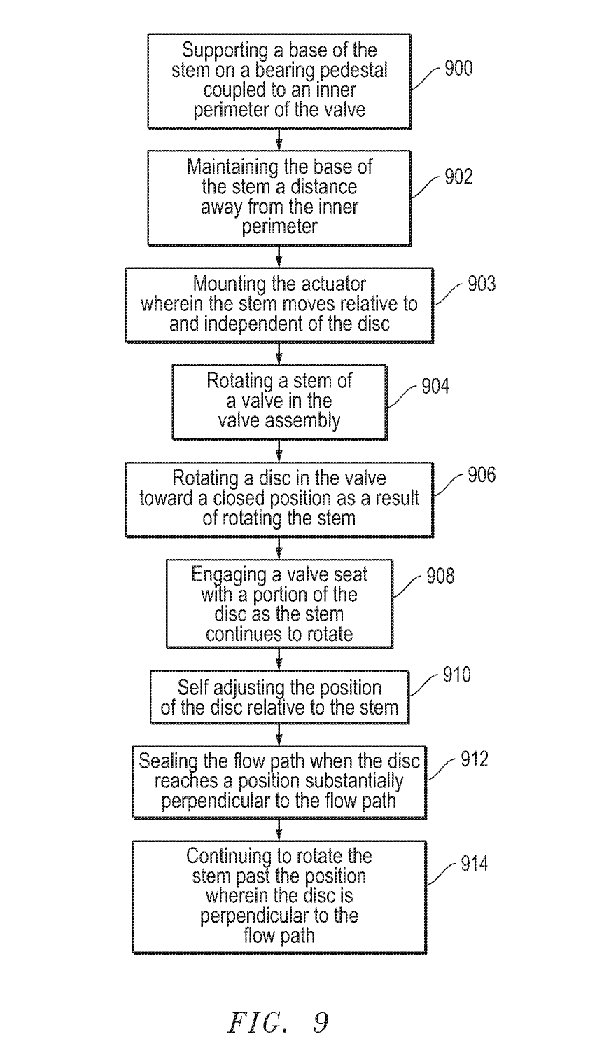

FIG. 9 depicts a flow chart depicting a method of using the valve assembly in a piping system. The method begins at block 900 wherein the base of the stem is supported on the bearing pedestal. The bearing pedestal may be coupled to the inner diameter of the valve and may be any of the pedestals described herein. The flow continues at block 902 wherein the base of the stem is maintained a distance from the inner perimeter of the valve. The flow continues at block 903, wherein the actuator is mounted on the valve and wherein the stem 206 moves relative to and independent of the disc 202. The flow continues at block 904 wherein the stem is rotated in the valve assembly. The stem may be rotated by any actuator including those described herein. The flow continues at block 906 wherein the disc is rotated in the valve toward a closed position as a result of the rotating of the stem. The flow continues at block 908, wherein a valve seat is engaged with a portion of the disc as the stem continues to rotate toward the closed position. The flow continues at block 910, wherein the disc may self adjust relative to the longitudinal axis of the stem. The self adjustment may be caused by the disc self aligning with the seat, or any other suitable situation in the valve. The flow continues at block 912, wherein the flow is sealed when the disc reaches a position substantially perpendicular to the flow path. The flow continues at block 914, wherein the stem continues to rotate past the position wherein the disc is perpendicular to the flow path. The continued rotation may compress the metal to metal seal between the disc and the valve seat.

While the embodiments are described with reference to various implementations and exploitations, it will be understood that these embodiments are illustrative and that the scope of the inventive subject matter is not limited to them. Many variations, modifications, additions and improvements are possible. For example, the implementations and techniques used herein may be applied to any valve used for piping systems, such as in any quarter-turn valve such as a plug valve or a ball valve, and the like.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1-20. (canceled)

21. A valve assembly comprising:
a valve body having an outer perimeter defining the outer surface of the valve and an inner perimeter defining a flow path through the valve;
a closure member located within the inner perimeter of the valve body and configured to selectively close and open the flow path;
a valve seat located at least partially within the inner perimeter of the valve body and configured to engage a portion of the closure member when the closure member is in the closed position, thereby preventing flow through the flow path;
a stem configured to support the closure member within the flow path; and
a closure member-stem connector configured to rotationally couple the closure member to the stem while allowing the closure member to move relative to the stem along a longitudinal axis of the stem.

22. The valve assembly of claim 21, wherein the closure member-stem connection is a splined connection.

23. The valve assembly of claim 21, wherein the closure member-stem connection is a shaped connection.

24. The valve assembly of claim 21, wherein the longitudinal movement of the closure member relative to the stem allows the closure member to self-adjust during alignment of the closure member with the valve seat.

25. The valve of claim 21, further comprising an actuator configured to actuate the stem and thereby the closure member.

26. The valve of claim 21, wherein the closure member is a disc.

27. A valve comprising:
a valve body having an outer perimeter defining the outer surface of
the valve and an inner perimeter defining a flow path through the valve;
a closure member located within the inner perimeter of the valve body and configured to selectively close and open the flow path;
a valve seat located at least partially within the inner perimeter of the valve body and configured to engage a portion of the closure member when the closure member is in a closed position, thereby preventing flow through the flow path; and
a stem configured to support the closure member within the flow path and wherein a portion of the stem has an actuator offset, wherein the actuator offset is configured to actuate the closure member to a position that is a rotational degree beyond a position wherein the closure member is perpendicular to the flow path.

28. The valve of claim 27, wherein the rotational degree beyond the closed position is within a range of from 0.5 degree to 10 degrees.

29. The valve of claim 27, wherein the rotational degree beyond the closed position is within a range of from 1 degree to 5 degrees.

30. The valve of claim 27, wherein the actuator offset is configured to form a tighter seal between the closure member and the seat over the life of the valve assembly.

31. The valve of claim 27, further comprising a position indicator configured to visually identify the location of the closure member in the valve assembly.

32. The valve of claim 27, further comprising an actuator configured to actuate the stem and thereby the closure member.

33. A valve, comprising:
a valve body having an outer perimeter defining the outer surface of the valve and an inner perimeter defining a flow path through the valve;
a disc located within the inner perimeter of the valve body and configured to selectively close and open the flow path;
a valve seat located at least partially within the inner perimeter of the valve body and configured to engage a portion of the disc when the disc is in a closed position, thereby preventing flow through the flow path;
a stem configured to support the disc within the flow path wherein a portion of the stem has an actuator offset, wherein the actuator offset is configured to actuate the disc to a position that is a rotational degree beyond a position wherein the disc is perpendicular to the flow path;
a bearing pedestal configured to support the stem; and
a disc-stem connector configured to rotationally couple the disc to the stem while allowing the disc to move relative to the stem along a longitudinal axis of the stem.

34. The valve of claim 33, wherein the height of the bearing pedestal is at least two percent of the valve inner diameter and ten percent or more of the diameter of the stem;
wherein the disc-stem connection is a splined connection; and
wherein the rotational degree beyond the closed position is within a range of from 1 degree to 5 degrees.

35. A method for closing a flow path in a piping system having a valve assembly, comprising:
supporting a base of the stem on a bearing pedestal coupled to an inner perimeter of the valve;
maintaining the base of the stem a distance away from the inner perimeter on the bearing pedestal;
rotating a stem of a valve in the valve assembly;
rotating a closure member toward a closed position as a result of rotating the stem;
engaging a valve seat with a portion of the closure member as the stem continues to rotate;
self adjusting the position of the closure member relative to the stem along a longitudinal axis of the stem as the closure member engages the valve seat;
sealing the flow path when the closure member reaches a position substantially perpendicular to the flow path; and
continuing to rotate the stem past the position wherein the closure member is perpendicular to the flow path.

36. The method of claim 35, wherein continuing to rotate the stem further comprises rotating the stem 1 to 5 degrees beyond the position wherein the closure member is perpendicular to the flow path.

37. The method of claim 36, further comprising compressing a metal to metal seal between the closure member and the valve seat by continuing to rotate the stem.

38. The method of claim 35, further comprising mounting an actuator on the valve, wherein the stem moves relative to and independent of the closure member.

39. The method of claim 35, wherein the closure member is a disc.
